(19) United States
(12) Patent Application Publication
(10) Pub. No.: US 2018/0350371 A1
(43) Pub. Date: Dec. 6, 2018

(54) ADJUST OUTPUT SETTINGS BASED ON AN IDENTIFIED USER

(71) Applicant: Lenovo (Singapore) Pte. Ltd., Singapore (SG)

(72) Inventors: Amy Leigh Rose, Chapel Hill, NC (US); Nathan J. Peterson, Oxford, NC (US); Gary David Cudak, Wake Forest, NC (US); Jennifer Lee-Baron, Morrisville, NC (US); John Scott Crowe, Durham, NC (US)

(21) Appl. No.: 15/609,239

(22) Filed: May 31, 2017

(51) Int. Cl. G10L 17/22; G10L 17/24; G06F 3/16

(52) U.S. Cl. CPC G10L 17/22; G06F 3/167; G10L 17/24

(57) ABSTRACT

One embodiment provides a method, including: receiving, at an information handling device, voice data; identifying a user associated with the voice data; and adjusting, based on the identified user, at least one output setting of the information handling device. Other aspects are described and claimed.

### BACKGROUND

Information handling devices (“devices”), for example smart phones, tablet devices, smart speakers, laptop and personal computers, and the like, may be capable of receiving user command inputs and providing outputs responsive to the input. Generally, a user interacts with a voice input module, for example embodied in a personal assistant through use of natural language. This style of interface allows a device to receive voice inputs from a user, process those inputs, and provide audible outputs according to preconfigured output settings (e.g., preconfigured output volume, preconfigured output speed, etc.).

### BRIEF SUMMARY

In summary, one aspect provides a method, comprising: receiving, at an information handling device, voice data; identifying a user associated with the voice data; and adjusting, based on the identified user, at least one output setting of the information handling device.

Another aspect provides an information handling device, comprising: a processor; a memory device that stores instructions executable by the processor to: receive voice data; identify a user associated with the voice data; and adjust, based on the identified user, at least one output setting of the information handling device.

A further aspect provides a product, comprising: a storage device that stores code, the code being executable by a processor and comprising: code that receives voice data; code that identifies a user associated with the voice data; and code that adjusts, based on the identified user, at least one output setting of the information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting an output setting of output provided to a user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.).

Conventionally, digital assistants may provide output at a single universal setting (e.g., at a particular volume, at a particular speed, etc.). For example, responsive to receiving a query from User A, a device may provide output at volume X and speed Y. Responsive to receiving another query from User B, the device may provide output at the same volume level and speed that it did for User A. However, these conventional methods of providing output do not consider that different users may benefit from receiving output at different output settings. For example, responsive to receiving a query to spell a word, a six year old user would likely need the word to be spelled slower than an adult-aged user. As another example, non-native English speakers may need English language output provided to them at a slower pace so that they can understand the output better.

Although existing solutions allow the output settings to be adjusted, this requires additional action from a user (e.g., physically interacting with a volume switch, reconfiguring output speed settings in an application, etc.). Furthermore, in situations where multiple users interact with a single device (e.g., where members of a family interact with a dedicated smart speaker such as the Amazon Echo®, etc.), constantly adjusting the output settings of the device may prove to be burdensome and time-consuming. Additionally, many users (e.g., young children, elderly individuals, etc.) may be unaware of how to adjust these settings and may be forced to receive output at the current or default output setting.

Accordingly, an embodiment provides a method for automatically adjusting at least one output setting associated with a device based upon an identification of a user interacting with the device. In an embodiment, voice data (e.g., voice command input, voice query input, etc.) may be received at a device from at least one user. An embodiment may then analyze the voice data to determine at least one characteristic associated with the voice data (e.g., a voice signature associated with a user, an accent associated with the voice data, a predefined word included in the voice data, etc.). Using the analyzed voice data, an embodiment may identify a user associated with the voice data. In an embodiment, the identification of a user may comprise identifying a user profile associated with a user. An embodiment may then adjust, based on the identified user or user profile, at least one output setting (e.g., output volume, output speed, output accent, etc.) of output provided by the device, or another device operatively coupled to the device. Such a method may enable a user to receive output using output settings that are optimal to that particular user's ability to properly understand and/or perceive the output.

The illustrated example embodiments will be best understood by reference to the figures. The following description is intended only by way of example, and simply illustrates certain example embodiments.

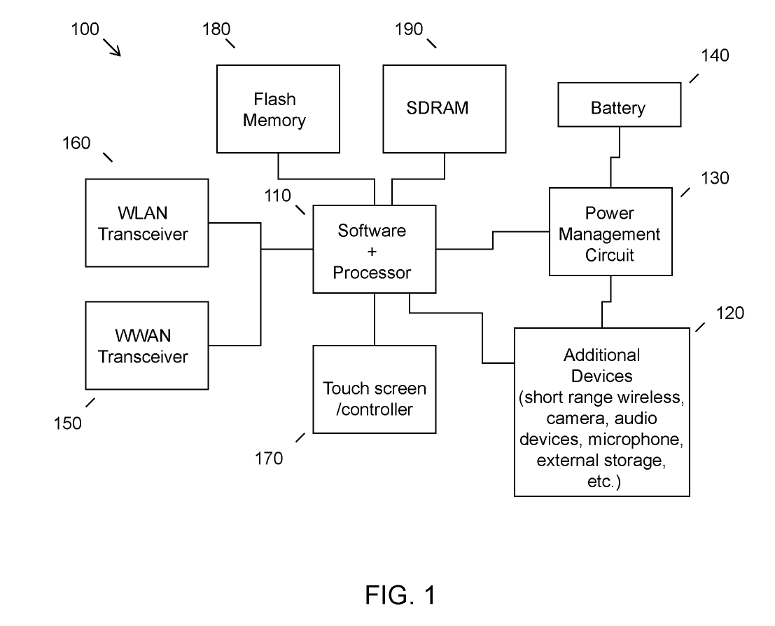

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

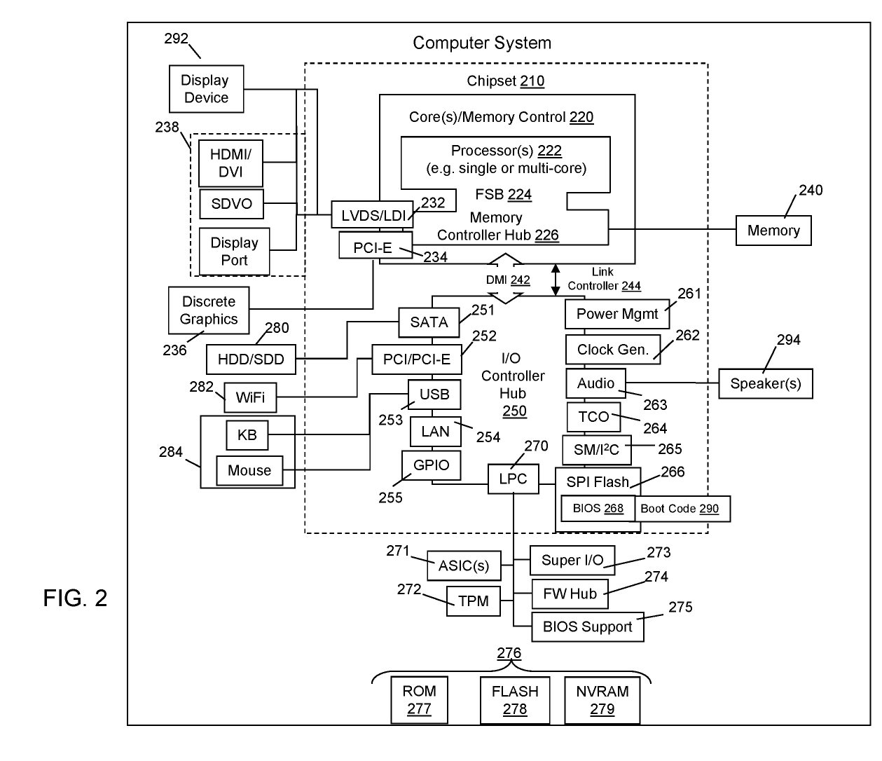

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

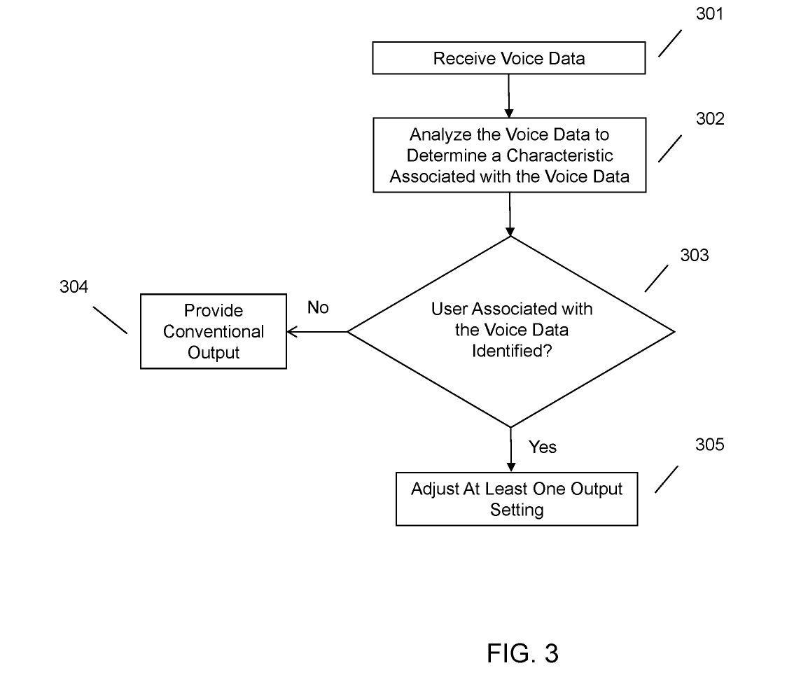

Referring now to FIG. 3, an embodiment may adjust an output setting of an information handling device based upon an identification of a user interacting with the device. At 301, an embodiment may receive voice input from at least one user. The voice input may be any type of input such as a command input, query input, and the like. In an embodiment, the voice input may be received at an input device (e.g., a microphone, a speech capture device, etc.) operatively coupled to a speech recognition device. In an embodiment, the speech recognition device may or may not contain a display screen.

In an embodiment, the input device may be an input device integral to the speech recognition device. For example, a smart phone may be disposed with a microphone capable of receiving voice input data. Alternatively, the input device may be disposed on another device and may transmit received voice input data to the speech recognition device. For example, voice input may be received at a smart speaker that may subsequently transmit the voice data to another device (e.g., to a user's smartphone for processing, etc.). Voice input data may be communicated from other sources to the speech recognition device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive voice input data by maintaining the input device in an active state. The input device may, for example, continuously detect voice input data even when other sensors (e.g., cameras, light sensors, speakers, other microphones, etc.) associated with the speech recognition device are inactive. Alternatively, the input device may remain in an active state for a predetermined amount of time (e.g., 30 minutes, 1 hour, 2 hours, etc.). Subsequent to not receiving any voice input data during this predetermined time window, an embodiment may switch the input device to a power off state. The predetermined time window may be preconfigured by a manufacturer or, alternatively, may be configured and set by one or more users.

At 302, an embodiment may analyze the voice data to determine at least one characteristic associated with the voice data. Subsequently, at 303, using the determined characteristics, an embodiment may identify a user, user group, or user profile associated with the voice data. In an embodiment, the analysis may be conducted, for example, using known voice input analysis techniques (e.g., spectrogram analysis, speech parsing, word association, frequency detection, amplitude detection, etc.). In an embodiment, the analysis may be conducted in real-time (e.g., as a user is providing the voice input, etc.).

In an embodiment, a characteristic associated with the voice data may be any characteristic that is particular to a specific user, or particular to a specific user group (e.g., age group, ethnicity group, etc.). In an embodiment, a characteristic associated with the voice data may comprise a voice signature. Each user may have a voice signature that is particular to that user. A voice signature may be a particular way of speaking unique to a particular person, for example, similar to a written signature, biometric signature, and the like. A voice signature may include the manner in which a person talks (e.g., speed of input, volume of input, accents, etc.), sound associated with the person talking (e.g., frequency of the voice, amplitude of the voice, etc.), and any other characteristics of the voice which can be used to distinguish between two or more people. By determining a voice signature associated with the received voice data, an embodiment may identify a corresponding user (e.g., by comparing the determined voice signature to a database of stored voice signatures, etc.).

In an embodiment, a characteristic associated with the voice data may be associated with a user's age. An embodiment may determine (e.g., using spectrogram analysis, etc.) an age, or approximate age, of the user providing voice data to the device. For example, an embodiment may be able to differentiate between a child aged user providing voice input to the device and an adult aged user providing voice input to the device. In an embodiment, data received from other sensors (e.g., cameras, other sensors, etc.), in addition to the data derived from the voice data, may be used to identify a user's age.

In an embodiment, a characteristic associated with the voice data may comprise a predefined word or phrase included in the voice data. The predefined word or phrase may be associated with an identity of the user and may be provided before, or as, a user is providing voice input to the device. In an embodiment, the predefined word may be associated with the user's name. For example, a user providing input to the device may state their name prior to providing the input. Subsequent to identifying the user based on their name, an embodiment may access, for example, a stored user profile associated with the particular user.

In an embodiment, a characteristic associated with the voice data may be associated with a user's accent. An embodiment may determine (e.g., using spectrogram analysis, etc.) an accent associated with the voice data and may associate that accent with an ethnicity of a user. For example, a non-native English user may provide input to the device and an embodiment may analyze the received input to determine an accent that the input was provided in. An embodiment may thereafter identify that the user is a non-native English speaker and/or identify the particular ethnic group that is associated with the determined accent (e.g., input provided in a French accent may be associated with a user from France or Canada).

In an embodiment, identifying a user, at 303, may comprise identifying a user profile associated with a user. In an embodiment, a device may store (e.g., at a storage location integral to the device or at a remote storage location accessible by the device, etc.) one or more user profiles. Each user profile may be associated with an individual user. In an embodiment, multiple users may access and use a single device. In such a situation, an embodiment may identify a user prior to accessing a user profile associated with that particular user. For example, multiple users may have the ability to access a device (e.g., a smart phone, a dedicated smart speaker, a laptop computer, a desktop computer, etc.) by logging into a user profile.

Each user profile may contain a variety of settings, including learned output settings, which may be specific to the identified user. For example, User A may gain access to a user profile on a device by providing user identification data (e.g., a digital fingerprint, user-associated passcode, user credentials, biometric data, device data, etc.) to an input device. Subsequent to granting User A access to their user profile, an embodiment may access output setting information associated with User A's profile and correspondingly adjust the output settings of the device in compliance with the data in User A's profile. If User B logs in to a user profile associated with User B on the same device, an embodiment may access output setting data specific to User B rather than the output setting data associated with User A.

Responsive to identifying, at 303, a user associated with the voice data, an embodiment may adjust, at 305, at least one output setting. In an embodiment, the speech recognition device, or another device associated with the speech recognition device, may provide output to a user. The output may be audio output, visual output, a combination thereof, or the like. In an embodiment, the audible output may be provided through a speaker, another output device, and the like. In an embodiment, the visual output may be provided through a display screen, another display device, and the like. In an embodiment, the output device may be integral to the speech recognition device or may be located on another device. In the case of the latter, the output device may be connected via a wireless or wired connection to the speech recognition device. For example, a smart phone may provide instructions to provide audible output through an operatively coupled smart speaker.

In an embodiment, an output setting may be associated with a way the output is provided to a user. In an embodiment, regarding audible output, an output setting may correspond to an output speed (e.g., how quickly a device recites natural language output, etc.), an output volume (e.g., how loudly a device recites natural language output, etc.), and the like. In an embodiment, regarding visual output (e.g., words provided on a display screen, etc.), an output setting may correspond to at least one display setting and may comprise at least one of an output speed (e.g., how quickly words are displayed on a display screen, etc.), output size (e.g., the font size of the words displayed on a display screen, etc.), output type (e.g., font style of the displayed words, etc.), and the like. In another embodiment, the output setting may correspond to a device output is provided from and/or provided on. For example, output may be provided from the speech recognition device, or, it may be provided from another device operatively coupled to the speech recognition device.

In an embodiment, an output setting may be adjusted based upon the identified user or the identified user profile. In an embodiment, the output setting may be automatically adjusted. For example, responsive to identifying a particular user, an embodiment may automatically adjust at least one output setting associated with the user without any other additional adjustment action on the part of the user. The following paragraph refers to a number of examples of output setting adjustment, however, these examples are not intended to be limiting.

In an embodiment, audible output speed and/or visual output speed may be adjusted (e.g., increased or decreased, etc.) based on the identified age of the user. For example, a younger aged user may benefit from receiving output at a slower speed than a middle aged user (e.g., in order to better comprehend the output, etc.). In the same vein, audible output speed and/or visual output speed may be adjusted based on identifying that the user is not a native speaker of the language associated with the output or by identifying that the user is associated with a particular ethnic group. For example, a non-native Spanish user may benefit from receiving Spanish language output at a slower speed than a native Spanish speaking user so that they may better understand the Spanish language output.

In an embodiment, audible output volume may be adjusted (e.g., increased or decreased, etc.), for example, based on the identified age of the user. For example, a senior user who may have trouble hearing may benefit from receiving output at a higher volume than a younger aged user. In an embodiment, the device on which the output is provided may be adjusted based upon the identified user. For example, if User A requests to play a song, that song may be played locally (e.g., on User A's smartphone, etc.) whereas if User B requests to play a song, an embodiment may play the song on another device (e.g., a smart speaker, etc.).

In an embodiment, a user profile storing output settings for a user may be automatically updated based upon received user inputs. For example, subsequent to providing output to a user at speed X, an embodiment may receive input from the user decreasing the output speed to speed Y. An embodiment may then store this new output speed in the user's profile and may thereafter provide output to the user at speed Y instead of at speed X. Although the aforementioned example referred exclusively to output speed, this example is not intended to be limiting and other output settings in a user's profile may be automatically adjusted based on received user inputs.

Responsive to not identifying, at 303, a user or a user profile associated with the voice data, an embodiment may provide, at 304, output using conventional output settings. For example, an embodiment may provide output at a pre-configured or existing speed and/or volume.

The various embodiments described herein thus represent a technical improvement to conventional output techniques. Using the techniques described herein, an embodiment may identify a user based on an analysis of voice data provided to the device. An embodiment may then automatically adjust an output setting of output provided by the device based on the identified user. Such techniques enable a user to receive output at settings that are associated with the user's preferred output settings.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an information handling device, voice data;
identifying a user associated with the voice data; and
adjusting, based on the identified user, at least one output setting of the information handling device, wherein the at least one output setting comprises an output speed.

2. The method of claim 1, wherein the identifying comprises identifying at least one characteristic associated with the voice data.

3. The method of claim 2, wherein the at least one characteristic comprises a voice signature associated with the voice data.

4. The method of claim 2, wherein the at least one characteristic comprises an accent associated with the voice data.

5. The method of claim 2, wherein the at least one characteristic comprises a predefined word included in the voice data.

6. The method of claim 1, wherein the at least one output setting comprises at least one of the output speed and an output volume.

7. The method of claim 1, wherein the at least one output setting comprises at least one display setting for a display device operatively coupled to the information handling device.

8. The method of claim 1, wherein the at least one output setting comprises providing output to at least one other device.

9. The method of claim 1, further comprising accessing a user profile associated with the identified user.

10. The method of claim 9, further comprising updating the user profile based upon received user inputs.

11. The method of claim 9, wherein the adjusting the at least one output setting comprises adjusting the at least one output setting based upon a setting identification stored in the user profile.

12. The method of claim 1, wherein the adjusting comprises adjusting based upon an age group of the user.

13. An information handling device, comprising:
a processor;
a memory device that stores instructions executable by the processor to:
receive voice data;
identify a user associated with the voice data; and
adjust, based on the identified user, at least one output setting of the information handling device, wherein the at least one output setting comprises an output speed.

14. The information handling device of claim 13, wherein the instructions executable by the processor to identify comprise instructions executable by the processor to identify at least one characteristic associated with the voice data.

15. The information handling device of claim 14, wherein the at least one characteristic comprises a voice signature associated with the voice data.

16. The information handling device of claim 14, wherein the at least one characteristic comprises a predefined word included in the voice data.

17. The information handling device of claim 13, wherein the at least one output setting comprise at least one of the output speed and an output volume.

18. The information handling device of claim 13, wherein the at least one output setting comprises at least one display setting for a display device operatively coupled to the information handling device.

19. The information handling device of claim 13, wherein the instructions are further executable by the processor to access a user profile associated with the identified user and wherein the instructions are further executable by the processor to update the user profile based upon received user inputs.

20. The information handling device of claim 19, wherein the instructions executable by the processor to adjust the at least one output setting comprise instructions executable by the processor to adjust the at least one output setting based upon an setting identification stored in the user profile.

21. A product, comprising:
a storage device that stores code, the code being executable by a processor and comprising:
code that receives voice data;
code that identifies a user associated with the voice data; and
code that adjusts, based on the identified user, at least one output setting of the information handling device, wherein the at least one output setting comprises an output speed.
